(19) United States
(12) Patent Application Publication
(10) Pub. No.: US 2010/0191546 A1
(43) Pub. Date: Jul. 29, 2010

(54) METHODS AND APPARATUS TO AUTOMATICALLY GENERATE SUBSCRIPTIONS FOR HEALTHCARE EVENT TRACKING AND ALERTING SYSTEMS

(76) Inventors: Anuradha Kanamarlapudi, Bangalore (IN); Guruprasad Kambaloor Nagaraja, Bangalore (IN)

Correspondence Address: HANLEY, FLIGHT & ZIMMERMAN, LLC, 150 S. WACKER DRIVE, SUITE 2100, CHICAGO, IL, 60606, US

(21) Appl. No.: 12/362,238

(22) Filed: Jan. 29, 2009

(51) Int. Cl. G06Q 50/00; G06Q 10/00; G06F 17/30

(52) U.S. Cl. 705/3; 707/E17.014

(57) ABSTRACT

Methods and apparatus to automatically generate subscriptions for healthcare event tracking and alerting systems are disclosed herein. An example method of generating a subscription for a healthcare event tracking and alerting system includes automatically analyzing healthcare information of a medical data sharing system to determine an interest of a physician in a patient; obtaining a patient identifier corresponding to the patient from the healthcare information; obtaining a physician identifier corresponding to the physician; and associating the patient identifier with the physician identifier to generate a subscription to the healthcare event tracking and alerting system, wherein the subscription enables the physician to automatically receive notifications of data related to the patient.

### FIELD OF THE DISCLOSURE

The present disclosure relates generally to healthcare information systems and, more particularly, to methods and apparatus to automatically generate subscriptions for healthcare event tracking and alerting systems.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostic, or treatment information, into a medical information system during an ongoing medical procedure.

Medical practitioners, such as doctors, surgeons, and other medical professionals, rely on the clinical information stored in such systems to assess the condition of a patient, to provide immediate treatment to a patient in an emergency situation, to diagnose a patient, and/or to provide any other medical treatment or attention. Moreover, some information systems enable practitioners and/or healthcare facilities to share clinical information, especially given the increase in use of electronic records.

### SUMMARY

An example method of generating a subscription for a healthcare event tracking and alerting system includes automatically analyzing healthcare information of a medical data sharing system to determine an interest of a physician in a patient. Further, the example method includes obtaining a patient identifier corresponding to the patient from the healthcare information. Further, the example method includes obtaining a physician identifier corresponding to the physician. Further, the example method includes associating the patient identifier with the physician identifier to generate a subscription to the healthcare event tracking and alerting system, wherein the subscription enables the physician to automatically receive notifications of data related to the patient.

An example apparatus to generate a subscription for a healthcare event tracking and alerting system includes at least one detector to analyze healthcare information of a medical data sharing system to determine an interest of a physician in a patient. Further, the example apparatus includes a data extractor to obtain a patient identifier corresponding to the patient from the healthcare information, where the data extractor is to obtain a physician identifier corresponding to the physician. Further, the example apparatus includes an association creator to associate the patient identifier with the physician identifier to generate a subscription to the healthcare event tracking and alerting system, wherein the subscription enables the physician to automatically receive notifications of data related to the patient.

An example medical data sharing system configured to provide feedback to a healthcare practitioner includes a plurality of medical information systems to receive healthcare information implemented at a plurality of healthcare enterprises, wherein the enterprises are members of an agreement to share the healthcare information. Further, the example medical data sharing system includes a tracking and alerting system to automatically provide feedback to a healthcare practitioner by storing a subscription to healthcare information associated with a patient of interest to the practitioner. Further, the example medical data sharing system includes a subscription generator to generate the subscriptions by automatically detecting the interest in the patient by analyzing at least one of a search initiated by the physician and a healthcare document entered into the medical information systems in which the physician and the patient are listed.

### BRIEF DESCRIPTION OF THE DRAWINGS

FIG. 1 is a block diagram of an example medical information system.

FIG. 2 is a block diagram of an example apparatus that may be used to implement the example healthcare event tracking and alerting system of FIG. 1.

FIG. 3 is a block diagram of an example apparatus that may be used to implement the example subscription generator of FIG. 2.

FIG. 4 is a flow diagram representative of example machine readable instructions that may be executed to implement the example healthcare event tracking and alerting system of FIGS. 1 and/or 2.

FIG. 5 is a flow diagram representative of example machine readable instructions that may be executed to implement the example subscription generator of FIG. 3.

FIG. 6 is a block diagram of an example processor system that may be used to execute the machine readable instructions of FIGS. 4 and/5 to implement the example healthcare event tracking and alerting system of FIG. 1 and/or the subscription generator of FIG. 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The example methods, apparatus, systems, and/or articles of manufacture described herein can be used to automatically generate subscriptions for a healthcare event tracking and alerting system. An example healthcare event tracking and alerting system described herein provides a feedback loop for one or more healthcare professionals to automatically inform the healthcare professionals of recent events involving formerly treated patients and/or current patients (e.g., a patient under the care of a multi-physician team). The feedback loop notifies the healthcare professionals of new developments associated with the type of previously provided treatment. For example, if a patient undergoes a medical procedure for stomach cancer (e.g., with an oncologist), a gastroenterologist that the patient visited the previous year automatically receives a notification, along with the corresponding medical information (e.g., modality, severity, prescriptions, test results, and/or any medical report), from the example tracking and alerting system. Thus, unlike typical healthcare information systems, the example tracking and alerting system described herein enables a physician to, for example, confirm a diagnosis, be informed of a misdiagnosis, reevaluate a treatment approach for the previous patient, current patients, and/or future patients, and/or otherwise learn from the new information associated with the new healthcare events.

Further, the example event tracking and alerting system described herein can provide updates to members of a treatment team (e.g., a group of physicians from various areas of medicine treating a patient). Treatments involving a plurality of physicians across medical specialties are more becoming more common, especially given the increase in sub-specialties and the prevalence thereof. In such instances, the example tracking and alerting system described herein enables the different physicians to better collaborate on the care of the patient and to follow the medical events occurring throughout the treatment process (e.g., by being automatically updated when the patient experiences or undergoes a relevant medical event).

As described in greater detail below, the feedback loop of the example tracking and alerting system described herein is implemented by an example subscribe-publish model. Generally, the example subscribe-publish model automatically generates one or more subscriptions for a plurality of healthcare practitioners such that the healthcare practitioners are automatically made aware of any future or current healthcare events associated with one or more patients. The example tracking and alerting system tracks healthcare events (e.g., test results, procedures, complications, administrative processing, etc.) that are entered into a medical information system, preferably as the events occur (e.g., immediately after or during an examination of a patient, upon an admission or discharge of a patient, etc.) or at least shortly thereafter. To publish relevant information to one or more subscribing practitioners, the medical information system is periodically (or in response to a query or other stimulus) polled to obtain data associated with newly entered healthcare events. In some examples, the medical information is obtained automatically in response to the medical information system being altered (e.g., when new healthcare information is added to the medical information system). Medical data obtained from one or more of the these processes is then communicated to the corresponding subscribing practitioners.

In some examples, a clinical relationship between the subscribing practitioners and the patients associated with any newly entered and/or found medical data is determined before conveying the newly entered and/or found medical data to the subscribing practitioner. As a result, in such examples, the information sent to the subscribing practitioners is restricted to medical information related to the treatment provided to the former/current patient by the practitioner. For example, a cardiologist having a subscription to a patient that the cardiologist treated the previous year for an arrhythmia may not receive a medical event (e.g., the example tracking and alerting system may not publish the report associated with the medical event to the cardiologist) in which the patient fractured a wrist. On the other hand, the cardiologist may receive a notification if the patient experiences stroke-related symptoms or actually suffers a stroke.

As described in greater detail below, the example methods, apparatus, systems, and/or articles of manufacture described herein automatically generate the subscriptions of the subscribe-publish model to enable the example healthcare event tracking and alerting system to provide relevant medical to appropriate physicians (e.g., those physicians with a medical relationship with a patient and/or those physicians having some type of interest in the treatment of a patient). The example methods, apparatus, systems, and/or articles of manufacture described herein alleviate or, in some instances, eliminate the need for a physician to actively subscribe to a patient and the medical data associated therewith. Rather, the example methods, apparatus, systems, and/or articles of manufacture described herein analyze action(s) taken by a physician, interaction(s) between the physician and a patient, medical data accessed by the physician, and/or any other suitable source(s) of information to make one or more assumptions as to the interest of the physician in one or more patients and any medical data related thereto. The assumptions are then used to generate one or more subscriptions reflecting the interest of the physician in medical data related to the corresponding patient. Additionally or alternatively, the assumptions can be used to automatically and/or immediately communicate newly entered medical information related to a healthcare event to the corresponding physician. For example, as soon as the medical information is entered into an information system, the physician receives the medical information and/or a notification thereof).

Given the large volume of patients treated by many physicians, the added task of having to create a subscription in a tracking and alerting system may be burdensome and/or error-prone. For example, more pressing matters are likely to consume most of a physician's time, leading to a delay in creating the subscriptions. As greater amounts of time pass between treatment and the creation of the subscription, the likelihood of erroneous entries and/or omissions increases. Additionally or alternatively, a physician may delegate the task of creating subscriptions to one or more support staff members, thereby decreasing overall productivity of an office, clinic, emergency room, etc. and tying up resources that are better utilized elsewhere. Using the example methods, apparatus, systems, and/or articles of manufacture described herein, neither the physician, support staff, or any other party that may be charged with the task of creating the subscriptions, is burdened with such a duty.

Rather, the example methods, apparatus, systems, and/or articles or manufacture described herein are capable of utilizing information from, for example, other regular activities performed by healthcare practitioners and/or existing information. For example, as described in greater detail below, a subscription generator may be configured to detect a search performed by a physician on a document sharing system involving the identity of a patient. The example subscription generator extracts information related to the search (e.g., an identifier associated with the patient that is the subject of the search and an identifier associated with the searching physician) and uses the extracted data to generate a subscription for the physician corresponding to the identified patient.

Additionally or alternatively, the example subscription generator may be configured to analyze documents recently added to a document sharing system. In such instances, the example subscription generator extracts identifying information (e.g., metadata associated with the identities of a patient and a physician in an electronic document sharing system) from newly entered medical documentation and uses the extracted identifying information to generate a subscription for any identified physician(s) corresponding to any identified patient(s). In some examples, the newly entered medical documentation is immediately communicated to the identified physician(s) (e.g., via an email, page, text message, telephone call, etc.).

Additionally or alternatively, the example subscription generator may be configured to access one or more external sources of medical information (e.g., databases located at an external or separate medical enterprise that may or may not be part the document sharing system) to obtain information related to possible associations between physician(s) and patient(s). If such information is obtained, the example subscription generator extracts identifying therefrom in a similar manner as the subscription generator may extract identifying information from medical documentation recently entered into the document sharing system in which the subscription generator is implemented.

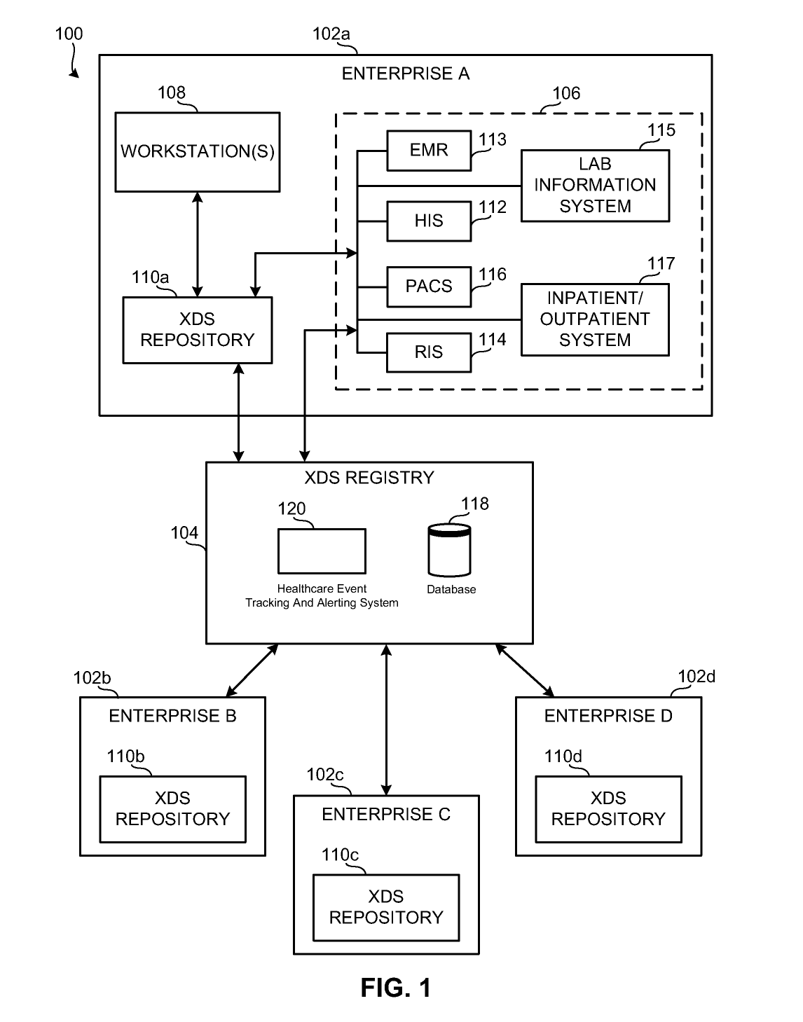

The example methods, apparatus, systems, and/or articles of manufacture described herein to automatically generate subscriptions for a healthcare event tracking and alerting system can be implemented on any suitable medical data sharing system. For example, the example tracking and alerting system described herein can be implemented in a Cross-Enterprise Document Sharing (XDS) system, which is being developed through the Integrating Healthcare Enterprise (IHE) initiative. With the increase in use of electronic medical records, there is an increased recognition of the advantages of sharing medical data among healthcare facilities (e.g., a physician's office, a hospital, a clinic, etc.). This has led to the development of medical data sharing systems such as the XDS system. In particular, the XDS system is an integration profile that facilitates registration, distribution, and access to medical data among a plurality of healthcare facilities or enterprises. The XDS profile establishes a common set of policies for a group (referred to as an Affinity Domain in IHE XDS terminology) of healthcare facilities or enterprises that have agreed to share medical data using a common infrastructure. As shown in greater detail below in connection with FIG. 1, an XDS system generally includes four main components: (1) a document registry to index medical reports using metadata or other identifying data; (2) document sources that provide data related to medical events (e.g., test results, medical reports, and/or metadata associated with the medical reports); (3) one or more document repositories that store medical reports and communicate with the document registry to retrieve documents to be shared; and (4) one or more document consumers that receive information associated with medical events.

The example methods, apparatus, systems, and/or articles of manufacture described herein to automatically generate subscriptions for a healthcare event tracking and alerting system can also be configured to be interoperable with other information systems, such as physician portal type applications. In such instances, an application programming interface (API) may enable third party applications to communicate information related to the example healthcare event tracking and alerting system (e.g., newly entered medical reports associated with a patient to which a physician subscribes) to one or more subscribing physicians.

FIG. 1 is a block diagram of an example medical data sharing system 100 capable of implementing the example methods, apparatus, systems, and/or articles of manufacture described herein to automatically generate subscriptions for healthcare event tracking and alerting systems. The example medical data sharing system 100 of FIG. 1 implements an XDS integration profile to facilitate the sharing of medical data among a plurality of healthcare enterprises 102a-d via a common registry 104. While the example medical data sharing system 100 of FIG. 1 is shown as implemented by an XDS integration profile, any other or additional suitable medical data sharing system can be used to implement the example methods and apparatus described herein.

In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown for purposes of brevity and not limitation.

The example hospital 102a includes a medical information system 106, one or more workstations 108, and a repository 110a. The medical information system 106 includes a hospital information system (HIS) 112, an electronic medical record system (EMR) 113, a radiology information system (RIS) 114, a lab information system 115, a picture archiving and communication system (PACS) 116, and an inpatient/outpatient system 117. In the illustrated example, the hospital information system 112, the electronic medical record system 113, the radiology information system 114, the lab information system 115, the PACS 116, and the inpatient/outpatient system 117 are housed in the hospital 102a and locally archived. However, in other implementations, the hospital information system 112, the electronic medical record system 113, the radiology information system 114, the lab information system 115, the PACS 116, and/or the inpatient/outpatient system 117 may be housed one or more other suitable locations. Furthermore, one or more components of the medical information system 106 may be combined and/or implemented together. For example, the radiology information system 114 and/or the PACS 116 may be integrated with the hospital information system 112; the PACS 116 may be integrated with the radiology information system; and/or the six example information systems 112, 113, 114, 115, 116, and/or 117 may be integrated together. Preferably, information (e.g., test results, observations, diagnosis, discharges, admissions, etc.) is entered into the information system(s) 112, 113, 114, 115, 116, and/or 117 by healthcare practitioners (e.g., radiologists, physicians, technicians, administrators, etc.) before, after, and/or during a patient examination and/or testing session.

The hospital information system 112 stores healthcare information such as clinical reports, patient information, practitioner information, and/or financial data received from, for example, personnel at a hospital, clinic, and/or a physician's office. The EMR system 113 stores administrative information related to patients and/or practitioners, medical histories, current treatment records, etc. In some examples, the EMR system 113 stores information according to one or more departmental assignments and/or designations. The radiology information system 114 stores information such as, for example, radiology reports, messages, warnings, alerts, patient scheduling information, patient demographic data, patient tracking information, and/or physician and patient status monitors. Additionally, the radiology information system 114 enables exam order entry (e.g., ordering an x-ray of a patient) and image and film tracking (e.g., tracking identities of one or more people that have checked out a film). In some examples, information in the radiology information system is formatted according to the HL-7 (Health Level Seven) clinical communication protocol.

The lab information system 115 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. In some examples, the medical images are stored in the PACS 116 using the Digital Imaging and Communications in Medicine (DICOM) format. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116. The inpatient/outpatient system 117 stores information related to the admission and discharge of patients such as follow up schedules, patient instructions provided by a practitioner, prescription information, presenting symptoms, contact information, etc.

While example types of information are described above as being stored in certain elements of the medical information system 106, different types of healthcare data may be stored in one or more of the hospital information system 112, the EMR system 113, the radiology information system 114, the lab information system 115, the PACS 116, and/or the inpatient/outpatient system 117. Further, the information stored in these elements may overlap and/or share types of data.

The hospital information system 112, the EMR system 113, the radiology information system 114, the lab information system 115, the PACS 116, and/or the inpatient/outpatient system 117 may be in communication via, for example, a Wide Area Network (WAN) such as a private network or the Internet. More generally, any of the coupling(s) described herein, such as the coupling(s) between the registry 104 and any of the enterprises 102a-d, may be via a network. In such instances, the network may be implemented by, for example, the Internet, an intranet, a virtual private network, a wired or wireless Local Area Network, and/or a wired or wireless Wide Area Network. In some examples, the medical information system 106 also includes a broker (e.g., a Mitra Imaging's PACS Broker) to allow medical information and medical images to be transmitted together and stored together.

The workstation(s) 108 may be any equipment (e.g., a personal computer) capable of executing software that permits electronic data (e.g., medical reports) and/or electronic medical images (e.g., x-rays, ultrasounds, MRI scans, medical reports, test results, etc.) to be acquired, stored, or transmitted for viewing and operation. The workstation(s) 108 receive commands and/or other input from a user (e.g., a physician, surgeon, nurse, or any other healthcare practitioner) via, for example, a keyboard, mouse, track ball, microphone, etc. The workstation(s) 108 can communicate with each other, the medical information system 106, and/or, as described in greater detail herein, with the XDS repository 110a and registry 104 to obtain shared medical information and convey the same to the user of the workstation(s) 108. Further, the workstation(s) 108 are capable of implementing a user interface to enable a healthcare practitioner to interact with the medical data sharing system 100 and/or the registry 104 and the components thereof. Additionally, the user interface includes one or more options related to the example methods and apparatus described herein to provide a feedback loop regarding clinical events.

The repository 110a, which is shown as an XDS repository in the example of FIG. 1, facilitates the sharing of the documents generated by the medical information system 106 with other enterprises (e.g., enterprises 102b-d). In particular, the repository 110a receives images, medical reports, administrative information, financial data, insurance information, and/or other healthcare information from the medical information system 106 and stores such information in, for example, a database or any suitable data structure. Thus, to use XDS terminology, the medical information 106 is a document source that provides the repository 110a clinical data to be shared among the enterprises 102a-d. If necessary (e.g., when different formats of the received information are incompatible), the repository 110a translates or reformats (e.g., into Structured Query Language (SQL or standard text) the medical information, such as medical reports, to be properly shared among the enterprises 102a-d (e.g., to conform with the XDS integration profile). In some examples, the medical information is stored in, for example, the DICOM format, which enables medical images and corresponding medical information to be transmitted and stored together. As shown in the example of FIG. 1, each of the enterprises 102b-d includes an XDS repository 110b-d that functions in a similar manner as the repository 110a of the hospital 102a.

Further, the repository 110a receives metadata associated with the images, medical reports, administrative information, financial data, insurance information, and/or other healthcare information from the medical information system 106 and forwards the metadata to the registry 104, which stores the metadata in a database 118. The metadata is used by the registry 104 to index the healthcare information stored at the repository 110a (along with the information stored at the repositories of the other enterprises 102b-d). The metadata corresponds to one of more types of identifying information (e.g., identification numbers, patient names, record numbers, social security numbers, payment status indicators, or any other identifying) associated with, for example, medical reports stored at the repository 110a. As described in greater detail below, the registry 104 is capable of receiving queries into the contents of the repositories (e.g., the repository 110b of enterprise 102b) of the medical data sharing system 100 and using the indexed metadata to satisfy the queries. For example, the registry 104 can perform a search of its contents and provide feedback (e.g., requesting clinical data or an indication of the lack thereof) regarding the same to one or more of the enterprises 102a-d and/or, more specifically, the repositories 110a-d.

In some examples, the user interface described above and/or a separate, dedicated user interface implemented on the workstation(s) 108 enables a search of one or more components or elements of the medical data sharing system 100 and/or one or more external databases containing relevant healthcare information. A healthcare practitioner can use such a user interface to search medical resources using different criteria such as, for example, a patient name, a patient identification number, a social security number, date(s) of treatment(s), type(s) of treatment, and/or any other suitable search criteria. In some examples, the healthcare practitioner logs on to the medical data sharing system 100 before using the search interface and, thus, makes his or her identity known to the system. That is, the user interface is aware of which healthcare practitioner is using the system and, in some examples, creates an identification entry in a memory (e.g., a temporary memory entry) corresponding to the identified healthcare practitioner.

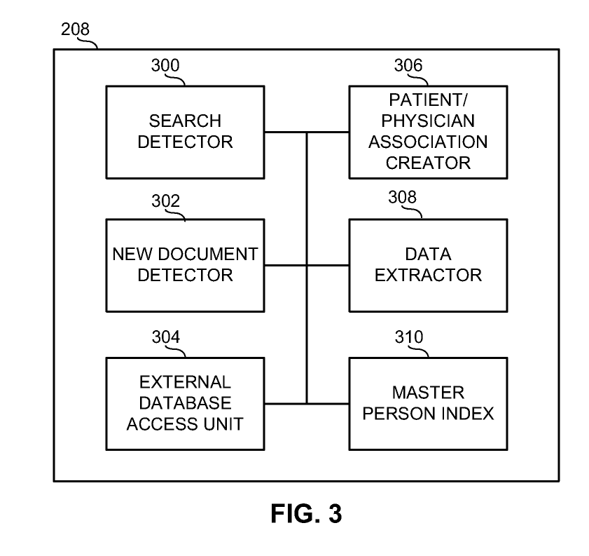

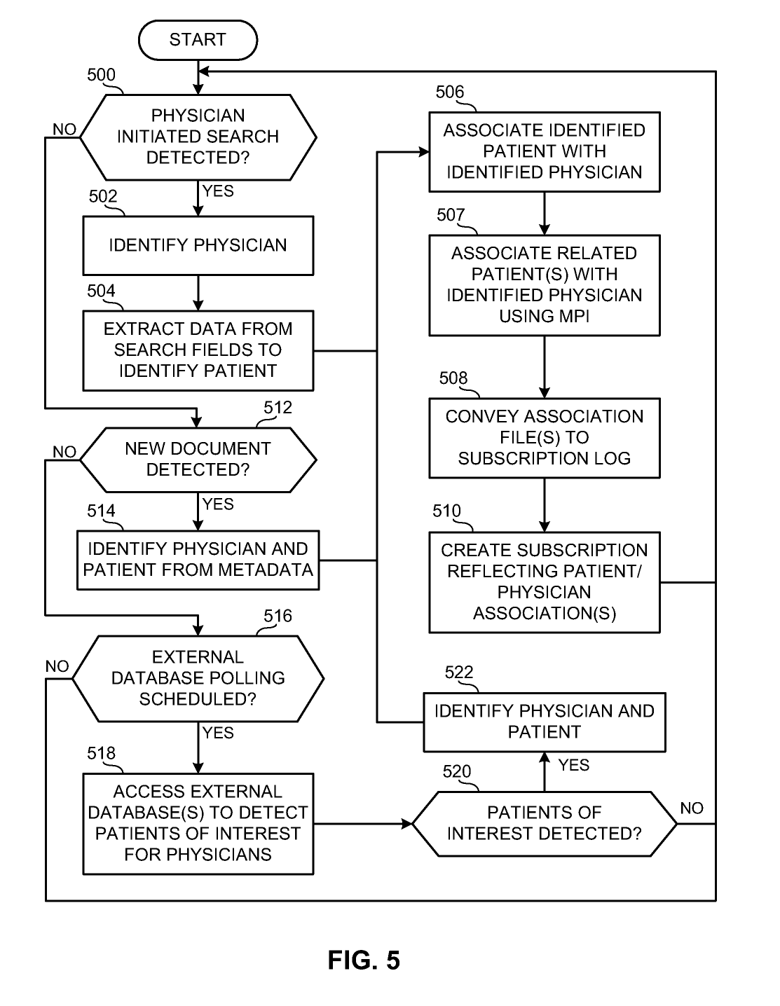

The registry 104 includes an example patient healthcare event tracking and alerting system 120. The example tracking and alerting system 120 provides a feedback loop to healthcare practitioners for information related to healthcare events related to former and/or current patients. Generally, the example tracking and alerting system 120 of FIG. 1 implements a subscribe-publish model to inform physicians concerned with a certain patient of medical events experienced by that patient. In particular, subscriptions are automatically generated for a plurality of physicians (or any other type of healthcare practitioner) based on analyses of action(s) taken by the physicians, interaction(s) between the physician and a patient, medical data accessed by the physician, and/or any other suitable source(s) of information capable of enabling a subscription generator to make one or more assumptions as to the interest of the physician in one or more patients and the healthcare data related thereto. An example subscription generator is described below in connection with FIGS. 3 and 5.

A record of each physician's subscriptions is stored and referenced by the tracking and alerting system 120 during a periodic polling session of the data shared among the enterprises 102a-d and/or in response to new information being entered into the one or more elements of the medical information system 106. If a new healthcare event is detected at any of the enterprises 102a-d (e.g., during a polling session in the repositories 110a-d as indicated by the indexed database 118 at the registry 104), the tracking and alerting system 120 determines which physician(s) (if any) are subscribed to the patient identified in the medical report associated with the detected new healthcare event(s). As described below in connection with FIGS. 3 and 5, if there is no subscriptions associated with the new healthcare event, the newly entered documentation may be analyzed to determine if one or more subscriptions are to be generated (e.g., by associating a treating physician with the patient associated with the clinical event). Information associated with the detected healthcare event is then published to the enterprise(s) 102a, 102b, 102c, and/or 102d associated with any subscribing practitioner(s) (e.g., to a hospital at which the practitioner works or an office from which the practitioner practices). In some examples, detected new healthcare information to be sent to the enterprise(s) is restricted to materials relevant to a relationship between the subscribing practitioner and the patient associated with the new clinical data.

Advantageously, the example tracking and alerting system 120 enables healthcare professionals to remain informed of healthcare events associated with current and/or former patients. As is the case with any type of learning environment, the more information one has regarding past approaches, conclusions, methods, techniques, etc., the more effectively one is able to evolve, improve, adapt, and/or, more generally, develop a medical practice and the skills involved therein. The feedback loop provided by the tracking and alerting system 120 provides information that can be used to, for example, confirm an initial diagnosis, identify a mistake, alter current practices, or make any other progress in healthcare treatment. Without the feedback loop provided by the example tracking and alerting system 120, physicians are more likely to be unaware of mistakes or ill-advised methods and, thus, more likely to repeat mistakes and/or continue to employ poor methods. Such feedback is often unavailable to physicians or, in the cases in which the information is available, not easily accessible and requiring proactive searching that is difficult, inefficient, and often inaccurate. These factors, combined with demanding schedules of most practitioners, decrease the likelihood that a practitioner will take the time and effort to obtain the feedback. The example tracking and alerting system 120 is described in greater detail below.

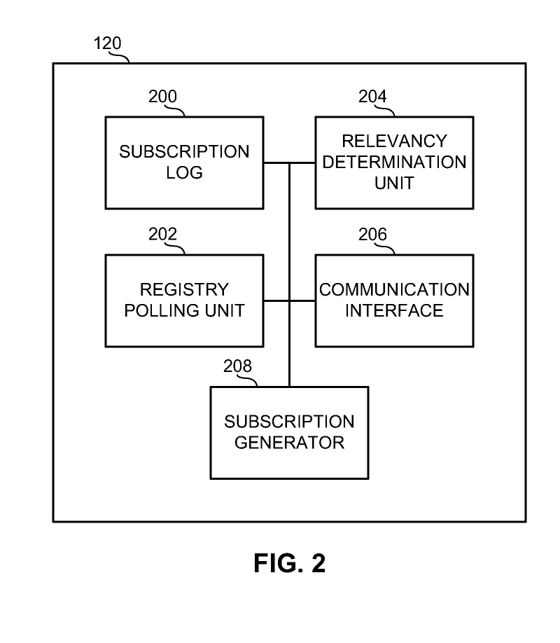

FIG. 2 is a block diagram of an example apparatus that may be used to implement the example tracking and alerting system 120 of FIG. 1. In the illustrated example of FIG. 2, the example tracking and alerting system 120 includes a subscription log 200, a registry polling unit 202, a relevancy determination unit 204, a communication interface 206, and a subscription generator 208. While an example manner of implementing the tracking and alerting system 120 of FIG. 1 has been illustrated in FIG. 2, one or more of the elements, processes and/or devices illustrated in FIG. 2 may be combined, divided, re-arranged, omitted, eliminated and/or implemented in any other way. Further, the example subscription log 200, the example registry polling unit 202, the example relevancy determination unit 204, the example communication interface 206, the example subscription generator 208, and/or, more generally, the example tracking and alerting system 120 of FIG. 2 may be implemented by hardware, software, firmware and/or any combination of hardware, software and/or firmware. Thus, for example, any of the example subscription log 200, the example registry polling unit 202, the example relevancy determination unit 204, the example communication interface 206, the example subscription generator 208, and/or, more generally, the example tracking and alerting system 120 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example subscription log 200, the example registry polling unit 202, the example relevancy determination unit 204, the example communication interface 206, the example subscription generator 208, and/or, more generally, the example tracking and alerting system 120 of FIG. 2 are hereby expressly defined to include a tangible medium such as a memory, DVD, CD, etc., storing the software and/or firmware. Further still, the example tracking and alerting system 120 of FIG. 2 may include one or more elements, processes and/or devices in addition to, or instead of, those illustrated in FIG. 2, and/or may include more than one of any or all of the illustrated elements, processes and devices.

To maintain a record of subscriptions generated by the example subscription generator 208 and/or subscriptions received from or more practitioners and/or the enterprises 102a-d, the example tracking and alerting system 120 of FIG. 2 includes the subscription log 200. The example subscription generator 208 is described below in connection with FIG. 3. As an additional or alternative approach to that of the subscription generator 208, a user interface implemented on the workstation(s) 108 may enable one or more physicians to directly subscribe to clinical events associated with one or more patients. When the tracking and alerting system 120 receives a subscription (e.g., from the subscription generator 208 or directly from a physician), the subscription log 200 stores a unique identifier associated with the identified patient in association with a stored entry for the corresponding physician. In the illustrated example, the physician entry is generated upon enrollment of the physician to the tracking and alerting system 120. The enrollment process includes associating contact information (e.g., an email address, phone number, fax number, mailing address, etc.) with the physician entry and providing account information corresponding to the account created for the physician. After generating such information, the subscription log 200 stores the same in association with the entry for each subscribing physician.

To obtain healthcare data (e.g., newly entered medical reports, financial data, admission/discharge updates, etc.) designated to be shared among the enterprises 102a-d, the example tracking and alerting system 120 of FIG. 2 includes the registry polling unit 202. As described above, the registry 104 stores identifying data (e.g., metadata) in that database 118, which is indexed to efficiently organize the data stored therein. In the illustrated example, the polling unit 202 performs a periodic search of the database 118 to determine whether any previously unidentified healthcare information is available. For example, when the polling unit 202 performs the search of the database 118 every twenty-four hours (e.g., in the morning hours or another time at which activity is minimal), the polling unit 202 may search for entries having a timestamp corresponding to the previous twenty-four hours and identify any such entries as new medical events. Additionally or alternatively, the polling unit 202 may maintain a list of previously identified entries, compare the list to the current contents of the database 118, and determine that any differences are newly entered healthcare events. Regardless of the method of searching, the polling unit 202 then generates a list of identified new healthcare events including, for example, patient identifiers, classifications, types of treatment, results, areas of practice, etc., any or all of which are designated by the metadata of the database 118.

To restrict the results provided by the polling unit 202 to information that is relevant to the physician and/or the interest expressed by the physician, the example tracking and alerting system 120 of FIG. 2 includes the relevancy determination unit 204. As described above, not every medical event experienced by a patient may be published to a subscribing physician. Referring to the above example, a cardiologist who has treated a patient for an arrhythmia may subscribe to the future healthcare events related to the patient. If the patient injures a wrist in the months following the arrhythmia treatment, the polling unit 202 will detect the injury and generate a list or report including an indication thereof. However, before being published to the respective subscribers, the list or report is conveyed to the relevancy determination unit 204 to remove medical data not of particular interest to one or more of the subscribers. In the example described above, the relevancy determination unit 204 compares the characterization (e.g., as identified by metadata retrieved from the database 118 by the polling unit 202) of the wrist injury to the practice area of the cardiologist to determine a clinical relationship between the patient and the subscribing physician. Additionally or alternatively, the relevancy determination unit 204 may compare the characterization of the wrist injury to the type of treatment provided by the cardiologist to determine a clinical relationship between the patient and the subscribing physician. In this case, the relevancy determination unit 204 determines that the cardiologist will not receive the medical data associated with the wrist injury due to the stark differences in both the pertinent practice areas and types of treatment.

The relevancy determination unit 204 includes one or more algorithms to make the publication determination described above. For examples, the algorithms may access a plurality of tables including medical characterizations, practice areas, treatment types, and the associations there between. Such data may be assigned weights or values to indicate strength of association. The relevancy determination unit 204 may use additional or alternative methods to determine the clinical relationship between detected new healthcare events and the subscribing physician and/or the treatment provided thereby.

To facilitate communication with the example components of the medical information system 100 described herein, the example tracking and alerting system 120 includes a communication interface 206. For example, the communication interface 206 may receive a list or report from the relevancy determination unit 204 including one or more entries from the database 118. In the illustrated example, the entries include metadata associated with healthcare documentation (e.g., medical reports, financial information, inpatient/outpatient data, etc.) stored on the repositories 110a-d at the enterprises 102a-d. In the illustrated example, the metadata includes information regarding which repository the associated healthcare documentation is stored. Thus, the communication interface 206 accesses the appropriate repository for each entry of the list or report to obtain the corresponding healthcare documentation.

Further, in the illustrated example, the list or report received by the communication interface 206 includes information regarding the identity of the subscribed physician(s) set to receive the newly identified healthcare documentation. Using such subscription information, the communication interface 206 then forwards the newly identified healthcare documentation to the corresponding enterprise (e.g., the enterprise listed as the address of the subscribing physician). The newly identified healthcare documentation can then be accessed at, for example, the workstation(s) 108 by, for example, logging into an account (e.g., using the user interface described above). In some examples, upon logging into an account, the subscribing physician is made aware of newly identified healthcare documentation in response to an approaching appointment with a certain patient.

In another example, the communication interface 206 may periodically generate and convey a communication (e.g., an email, page, test message, etc.) to the subscribing physicians having information related to some or all of the newly identified healthcare documentation. In such instances, the actual healthcare documentation (e.g., medical images, test results, finding of another physician, surgery results, etc.) can be included in the communication as attachments. Attaching the healthcare documentation alleviates the need for the subscribing physician to directly access the XDS repository to obtain the newly identified healthcare documentation.

Additionally or alternatively, the communication interface 206 may forward the newly identified healthcare documentation to another external or internal device or entity capable of providing access to the subscribing physician. For example, the communication interface 206 may forward the newly identified healthcare documentation to a server (e.g., a web server coupled to a network with which the healthcare event tracking and alerting system 120 is in communication) implementing a web page (e.g., a home page associated with one of the enterprises 102a-d) to which the subscribing physician has access (e.g., using a username and password). In some examples, the web server may include an implementation of an RSS (Really Simple Syndication, Rich Site Summary or RDF (Resource Description Framework Site Summary) feed capable of presenting constantly updated information. The newly identified healthcare documentation may be communicated via such an RSS feed to the subscribing physician on a home page. Further, certain portions of the information contained in the RSS feed may be emphasized to indicate that the patient associated with those certain portions of the RSS feed have an approaching appointment with the subscribing physician. In some examples, the frequency at which newly entered healthcare information is conveyed to the subscribing practitioner may depend on the method by which the communication interface 206 is set to convey the healthcare information to the subscribing practitioner.

Additionally or alternatively, the example communication interface 206 may determine whether the subscribing practitioner is scheduled to receive more than one notification of newly entered healthcare information and/or the healthcare information itself. In such instances, where the subscribing practitioner will likely receive numerous communications, the communication interface 206 may combine the individual communications into a bulk message or communication (e.g., a zip file including the newly entered healthcare information). Whether or not the communications are bundled together may depend on the type of notification by which the communication interface 206 is set to convey the healthcare information and/or on a preference of the subscribing practitioner.

FIG. 3 is a block diagram of an example apparatus that may be used to implement the example subscription generator 208 of FIG. 2. In the illustrated example of FIG. 3, the example subscription generator includes a search detector 300, a new document detector 302, an external database access unit 304, a patient/physician association creator 306, a data extractor 308, and a master person index (MPI) 310. While an example manner of implementing the subscription generator 208 of FIG. 2 has been illustrated in FIG. 3, one or more of the elements, processes and/or devices illustrated in FIG. 3 may be combined, divided, re-arranged, omitted, eliminated and/or implemented in any other way. Further, the example search detector 300, the example new document detector 302, the example external database access unit 304, the example patient/physician association creator 306, the example data extractor 308, the example MPI 310, and/or, more generally, the example subscription generator 208 of FIG. 3 may be implemented by hardware, software, firmware and/or any combination of hardware, software and/or firmware. Thus, for example, any of the example search detector 300, the example new document detector 302, the example external database access unit 304, the example patient/physician association creator 306, the example data extractor 308, the example MPI 310, and/or, more generally, the example subscription generator 208 of FIG. 3 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example subscription log 200, the example search detector 300, the example new document detector 302, the example external database access unit 304, the example patient/physician association creator 306, the example data extractor 308, the example MPI 310, and/or, more generally, the example subscription generator 208 of FIG. 3 are hereby expressly defined to include a tangible medium such as a memory, DVD, CD, etc., storing the software and/or firmware. Further still, the example subscription generator 208 of FIG. 3 may include one or more elements, processes and/or devices in addition to, or instead of, those illustrated in FIG. 3, and/or may include more than one of any or all of the illustrated elements, processes and devices.

The example search detector 300 of FIG. 3 enables an example method of automatically generating the subscriptions described herein. In particular, the example search detector 300 is triggered when a healthcare practitioner (e.g., a physician) accesses a search interface capable of searching the contents of the medical data sharing system 100 of FIG. 1, such as the XDS repositories 110a-d. As described above, the example workstation(s) 108 of FIG. 1 may implement such a search interface and may require a searching practitioner to log on to the system 100 before performing the search. The example search detector 300 determines that the searching practitioner has an interest in the subject of the search. For example, the practitioner may enter a patient identifier (e.g., a patient name, social security number, a number assigned by one or the enterprises 102a-d, etc.) to find some or all of the medical information associated with a former or current patient.

The search may or may not result in any new information for the identified patient. However, regardless of the search outcome, the search detector 300 assumes that the searching practitioner has an interest in the identified patient. For example, if a medical report including the patient identifier is entered into the medical data sharing system 100 sometime after the search described above, the searching practitioner is most likely still interested in the new medical report. Therefore, the example search detector 300 is configured to create a subscription associating the searching practitioner with the subject of the search. The resulting subscription is then conveyed to the subscription log so that the practitioner will be updated with any newly entered information related to the subject of the search via the tracking and alerting system 120.

To obtain the identifying information related to the patient (the subject of the search) and the searching practitioner, the example subscription generator 208 of FIG. 2 includes the data extractor 308. The example data extractor 308 is capable of accessing search files related to the search interface described above. Typically, search programs or elements log data entered into a search field for a certain period of time. In some examples, the data entered into the fields is stored in association with the field in which the data was entered. The example data extractor 308 can reference the search data stored in association with one or more patient identifier fields to obtain identifying information associated with the subject patient of any searches.

To create the subscription tying the searching practitioner to the search subject, the example subscription generator 208 of FIG. 2 includes the patient/physician association creator 306. The example patient/physician association creator 306 is capable of combining the patient identifier extracted by the data extractor 308 with the practitioner identifier stored by the workstation(s) 108 upon the practitioner logging on to the system 100. In particular, the example patient/physician association creator 306 creates, for example, a file and/or object capable of being conveyed and read by the subscription log 200 of FIG. 2. The file and/or object is then used as a subscription for the practitioner to any healthcare events related to the corresponding patient.

The example new document detector 302 enables another example method of automatically generating the subscriptions described herein. In particular, the example new document detector 302 is triggered when a clinical data is entered into the medical data sharing system 100 (e.g., in the XDS repository 110a via the medical information system 106). As described above, the medical information system 106 produces healthcare documents (e.g., x-rays, scans, three-dimensional renderings, test results, observations, diagnosis, financial records, admission/discharge records, etc.) to be shared and accessible via the XDS registry 104 of FIG. 1. Further, the healthcare documents include identifying data (e.g., metadata) associated with a patient, physician, treatment, healthcare enterprise, payment account, etc. The example new document detector 302 is triggered when such a healthcare document is entered into the system 100. In response, the new document detector 302 causes the example data extractor 308 to determine an identity of a patient associated with the healthcare document and an identity of a practitioner associated with the healthcare document using the identifying information thereof. The example new document detector 302 then assumes an interest of the identified practitioner in the identified patient.

In some examples, the new document detector 302 references the subscription log 200 of FIG. 2 to determine whether a subscription involving the identified practitioner and the identified patient already exists. If so, the example new document detector 302 may cease operations related to the newly entered medical document. Additionally or alternatively, if the new document detector 302 determines that a subscription involving the identified practitioner and the identified patient already exists, the new document detector 302 may cause the example communication interface 206 of FIG. 2 to immediately convey (e.g., via a page, email, text message, etc.) the detected new document to the identified practitioner. As described above, the communication interface 206 may or may not determine that one or more communications are to be bundled into a single communication. Otherwise, if no subscription involving the identified practitioner and the identified patient is present in the subscription log 200, the new document detector 302 causes the patient/physician association creator 306 to combine the identifiers (e.g., a patient identifier and a practitioner identifier) extracted by the data extractor 308 from the newly entered medical document. As described above, the example patient/physician association creator 306 creates a file and/or object to be used by the subscription log 200 as a subscription. Therefore, the practitioner will be updated with any newly entered information related to the patient identified in the newly entered medical document via the tracking and alerting system 120.

The example external database access unit 304 of FIG. 3 enables another example method of automatically generating the subscriptions described herein. In particular, the example external database access unit 304 is capable of communicating with one or more resources of healthcare information such as, for example, XDS repositories of other medical data sharing systems, subscription logs stored in external systems, alternative medical record storage resources at one or more of the enterprises 102a-d of FIG. 1, or any other type of healthcare information resource. The example external database access unit 304 may perform one or more searches and/or queries of such resource(s) to obtain information indicative of an interest of one or more practitioners in one or more patients. In some examples, the external database access unit 304 can monitor and/or listen to HL7 messages to obtain information indicative of an interest of one or more practitioners in one or more patients.

In some examples, the external database access unit 304 imports information from the external source(s) in bulk and/or at regular incremental updates and internally stores the information. With the information internally stored, the external database access unit 304 can operate while the external resource(s) are unavailable (e.g., offline and/or inoperable). That is, operation of the external database access unit 304 can be independent of the availability of the external resource(s). Further, the external database access unit 304 can operate independent of the schema, configuration, storage mechanisms, hierarchies, and/or layout of the external resource(s) by transferring (e.g., importing) the information through defined interfaces. For example, a database administrator can export data from a proprietary database into a spreadsheet (e.g., a Microsoft® Excel® spreadsheet, an XML file, etc.) such that the information can be accessed independent of the corresponding database schema.

The example external database access unit 304 of FIG. 3 may include a list of practitioners limited to those enrolled in the medical data sharing system 100 of FIG. 1 to use in the searches and/or queries of the external resource(s). If a search and/or query identifies a healthcare document including one of the practitioners listed in the external database access unit 304, the data extractor 308 extracts an identity of one or more patients related to the identified practitioner in the medical report.

In some examples, the external database access unit 304 references the subscription log 200 of FIG. 2 to determine whether a subscription involving the identified practitioner and the identified patient already exists. If so, the example external database access unit 304 may cease operations related to externally located healthcare documents. Otherwise, if no subscription involving the identified practitioner and the identified patient is present in the subscription log 200, the external database access unit 304 causes the patient/physician association creator 306 to combine the identifiers (e.g., a patient identifier and a practitioner identifier) extracted by the data extractor 308 from the externally located medical document. As described above, the example patient/physician association creator 306 creates a file and/or object to be used by the subscription log 200 as a subscription. Therefore, the practitioner will be updated with any newly entered information related to the patient identified in the externally located healthcare document via the tracking and alerting system 120.

The example MPI 310 of FIG. 3 enables another example method of automatically generating the subscriptions described herein. In particular, the example MPI 310 includes one or more databases storing information related to a plurality of associations held between people/patients. For example, a record corresponding to a first person listed in the MPI 310 of FIG. 3 may be stored with information regarding an association or relationship held between the first person and a second person. In one instance, the first and second persons are family members (e.g., husband and wife, parent and child, brothers, sisters, cousins, etc.) and that association or relationship is stored in the MPI 310. In other instances, the first and second persons are listed as emergency contacts of one another. The MPI 310 may include additional or alternative types of association or relationships.

The MPI 310 can use the information regarding the association held between persons to assume that a practitioner interested in the healthcare information associated with one person also has an interest in the healthcare information associated with a related person. For example, if the search detector 300, the new document detector 302, and/or the external database access unit 304 generate a subscription (e.g., using the patient/physician association creator 306) for a first practitioner to the healthcare information associated with the first person described above, the MPI 310 may be referenced to determine whether the first person is married. If so, the MPI 310 may cause the patient/physician association creator 306 to generate another subscription for the first practitioner to the healthcare information associated with the first person's wife, child, parent, etc. Thus, the MPI 310 takes advantage of a likelihood that one or more family members and/or otherwise related persons share a practitioner. In some examples, when this assumption (or any of the other assumptions described herein) proves to be incorrect, the practitioner may choose to cancel the subscription.

In the illustrated example of FIG. 3, the example subscription generator 208 is capable of implementing four example methods of automatically generating the subscriptions described herein. Specifically, the example subscription generator 208 of FIG. 3 includes the example search detector 300, the example new document detector 302, the example external database access unit 304, and the example MPI 310. The example subscription generator 208 of FIG. 3 may operate and/or utilize the example search detector 300, the example new document detector 302, and the example external database access unit 304 separately, at the same time, for the same task at once, and/or for different tasks at different times. In other words, the example subscription generator 208 of FIG. 3 can use one, a subset, or all of the example search detector 300, the example new document detector 302, and the example external database access unit 304 and the methods associated therewith for similar and/or separate tasks.

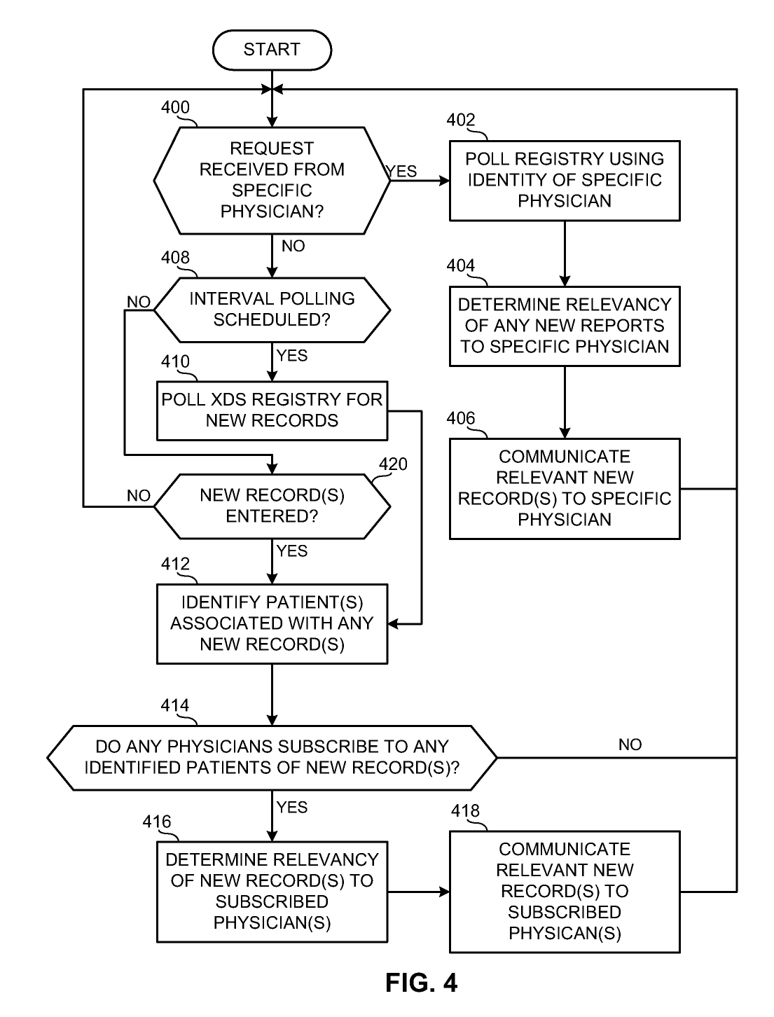

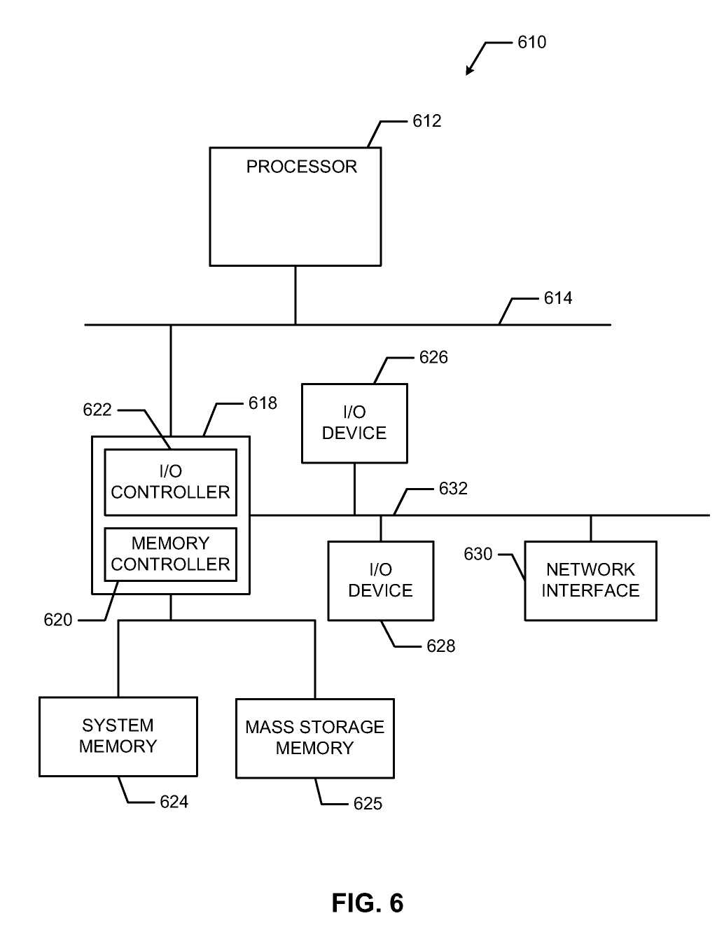

Turning to FIG. 4, the flow diagram depicted in FIG. 4 is representative of machine readable instructions that can be executed to implement the example tracking and alerting system 120 of FIGS. 1 and/or 2 to provide a feedback loop to one or more healthcare practitioners. The example processes of FIG. 4 may be performed using a processor, a controller and/or any other suitable processing device. For example, the example processes of FIG. 4 may be implemented in coded instructions stored on a tangible medium such as a flash memory, a read-only memory (ROM) and/or random-access memory (RAM) associated with a processor (e.g., the example processor 612 discussed below in connection with FIG. 6). Alternatively, some or all of the example processes of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 4 may be implemented manually or as any combination(s) of any of the foregoing techniques, for example, any combination of firmware, software, discrete logic and/or hardware. Further, although the example processes of FIG. 4 are described with reference to the flow diagram of FIG. 4, other methods of implementing the processes of FIG. 4 may be employed. For example, the order of execution of the blocks may be changed, and/or some of the blocks described may be changed, eliminated, sub-divided, or combined. Additionally, any or all of the example processes of FIG. 4 may be performed sequentially and/or in parallel by, for example, separate processing threads, processors, devices, discrete logic, circuits, etc.

In the illustrated example of FIG. 4, polling of the registry 104 (FIG. 1) can be triggered by a request from a physician and/or a scheduled polling session. For example, if the tracking and alerting system 120 is configured to poll the registry 104 once per twenty-four hours, a physician may prefer to check for newly identified healthcare information more frequently. Accordingly, a user interface (e.g., the user interface implemented by the workstation(s) 108 of FIG. 1) enables a subscribing physician to request a non-scheduled polling of the registry 104. If such a request is received by the tracking and alerting system 120 (block 400), the registry polling unit 202 (FIG. 2) polls the database 118 (FIG. 1) of the registry 104 using an identifier associated with the requesting physician (block 402). The unique identifier may be retrieved from or generated by, for example, the subscription log 200 (FIG. 2).

As described above, the registry polling unit 202 obtains any healthcare records deemed to be new (e.g., recently entered into the medical data sharing system 100 of FIG. 1) and generates a list or record of the detected results. In the illustrated example, because the polling is performed in response to a specific request from a physician (block 400), the polling unit 202 may only include the results the search associated with the requesting physician (e.g., using the requesting physician's unique identifier in comparison with the metadata of the database 118). The list or record is then conveyed to the relevancy determination unit 204 (FIG. 2) to filter or screen the polling results (block 404). As described above, the relevancy unit 204 determines whether any newly obtained healthcare records are pertinent to the clinical relationship between the requesting physician and the associated patient. Then, the communication interface 206 conveys any relevant healthcare information to the requesting physician by, for example, retrieving the corresponding healthcare records from one or more of the repositories 110a-d (FIG. 1) and communicating the same to an account associated with the subscription (e.g., as obtained from the subscription log 200) of the requesting physician (block 406). The contents of the physician's account can then be accessed via one or more of the workstation(s) 108.

Referring back to block 400, when a specific request has not been received from a subscribing physician and a polling session is scheduled (block 408), the polling unit 202 obtains any healthcare records deemed to be new (e.g., recently entered into the medical data sharing system 100 of FIG. 1) and generates a list or record of the detected results (block 410). The example polling unit 202 also identifies the patients associated with the detected results by, for example, extracting identifying data (e.g., patient identifiers, social security numbers, payment status indicators corresponding to financial records, etc.) (block 412). The subscription log is then accessed (e.g., by the polling unit 202) to determine whether any subscriptions are present in the subscription log 200 corresponding to the patient(s) associated with the newly entered healthcare record(s) (block 414). If one or more of the detected healthcare records involve patient(s) to which one or more physicians subscribe (block 414), the list or record generated by the polling unit 202 is conveyed to the relevancy determination unit 204. Otherwise, control returns to block 400.

As described above, the relevancy unit 204 determines whether any newly obtained medical reports are pertinent to the clinical relationship between the subscribing physician and the associated patient (block 416). Then, the communication interface 206 conveys any relevant healthcare information to the requesting physician by, for example, retrieving the corresponding healthcare records from one or more of the repositories 110a-d (FIG. 1) and communicating the same to an account associated with the subscription (e.g., as obtained from the subscription log 200) of the requesting physician (block 418). The contents of the physician's account can then be accessed via one or more of the workstation(s) 108. Control then returns to block 400.

Referring back to block 400, if a request from a specific physician is not received and an interval polling is not scheduled (block 408), the example new document detector 302 of FIG. 3 determines whether a new healthcare record has been received (block 420). As described above in connection with FIG. 3, in some examples, the tracking and alerting system 120 is configured to notify a subscribing physician of a newly entered healthcare record as soon as the record is entered into the medical information system 100. Thus, without waiting for one of the polling sessions described above, the tracking and alerting system 120 is capable of immediately informing a physician of a newly entered healthcare record. In some examples, the physician is able to set one or more subscription (e.g., in a preference setting) such that the immediate notification is enabled. For example, the physician may enable such a setting for a patient in critical or unstable condition. As shown in the example of FIG. 4, control passes to block 412 if the new document detector 302 of FIG. 3 detects a newly entered healthcare record. Otherwise, control passes to block 400.

Turning to FIG. 5, the flow diagram depicted in FIG. 5 is representative of example machine readable instructions that may be executed to implement the example subscription generator of FIG. 3 to automatically generate subscriptions for the example clinical event tracking and alerting system 120 of FIGS. 1 and 2. The example processes of FIG. 5 may be performed using a processor, a controller and/or any other suitable processing device. For example, the example processes of FIG. 5 may be implemented in coded instructions stored on a tangible medium such as a flash memory, a read-only memory (ROM) and/or random-access memory (RAM) associated with a processor (e.g., the example processor 612 discussed below in connection with FIG. 6). Alternatively, some or all of the example processes of FIG. 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 5 may be implemented manually or as any combination(s) of any of the foregoing techniques, for example, any combination of firmware, software, discrete logic and/or hardware. Further, although the example processes of FIG. 5 are described with reference to the flow diagram of FIG. 5, other methods of implementing the processes of FIG. 5 may be employed. For example, the order of execution of the blocks may be changed, and/or some of the blocks described may be changed, eliminated, sub-divided, or combined. Additionally, any or all of the example processes of FIG. 5 may be performed sequentially and/or in parallel by, for example, separate processing threads, processors, devices, discrete logic, circuits, etc.

The generation of subscriptions by the example subscription generator 208 (FIGS. 2 and 3) can be triggered by a prompt (e.g., according to a schedule programming into the subscription generator 208) and/or may continuously occur. In the illustrated example of FIG. 5, the subscription generator 208 continuously monitors the system 100 (FIG. 1) for a plurality of events and can be triggered in response thereto.

For example, the search detector 300 (FIG. 3) is triggered by a healthcare practitioner, such as a physician, initiating a search (block 500). As described above, the workstation(s) 108 include a search user interface to enable a physician to search for medical information related to a patient. To initiate the search, the practitioner logs on (e.g., via a user name and password) to the system 100 using, for example, one of the workstation(s) 108 and/or a remote communication system (e.g., a virtual private network) located elsewhere (e.g., a home or separate office of the physician). The search detector 300 identifies the physician using the user name and password entered to log on to the system 100 (block 502). In particular, the search detector 300 stores (e.g., temporarily in a cache) an identifier associated with the user name and/or password that corresponds to the physician. Alternatively, another healthcare practitioner associated with the physician (e.g., a member of a support staff such as an assistant, a nurse, an intern, etc.) may log on to the system 100 using another password to perform a search on behalf of the physician. In such instances, the password of the other practitioner is also associated with the physician and, thus, causes the search detector 300 to store an identifier associated with the physician (block 502).

To perform the search, the physician enters a patient identifier (e.g., an identification number and/or name) into a search field of the search interface to obtain information related to the patient of interest. The data extractor 308 (FIG. 3) extracts the data from the patient identifying search fields to identify the patient of interest (block 504). In particular, the data extractor 308 is capable of accessing search files related to the search interface. These files can be referenced to obtain information stored in association with one or more patient identifier fields.

Because the physician is searching for information related to the identified patient, the search detector assumes an interest in the patient on the part of the physician. Therefore, the search detector 300 causes the generation of a subscription associating the searching physician with the subject patient of the search. To generate the subscription, the search detector 300 (and/or any other suitable element(s) of the subscription generator 208) causes the patient/physician association creator 306 (FIG. 3) to generate a file and/or object in which the identified patient and the identified physician are tied together to indicate the interest of the physician in the patient (block 506).

In the illustrated example of FIG. 5, one or more additional subscriptions may be generated by the master person index (MPI) 310 of FIG. 3. As described above in connection with FIG. 3, the MPI 310 stores information regarding relationships and/or associations held between people. For example, the MPI 310 may indicate that a patient in which the searching practitioner express an interest has a wife, children, siblings, parents, etc. If so, it is likely that practitioner would also have an interest in these related persons. Thus, the MPI 310 is referenced and if certain relatives and/or associates are found in connection with the identified patient, the MPI 310 (and/or any other suitable element(s) of the subscription generator 208) causes the patient/physician association creator 306 to generate a file and/or object in which the relatives and/or associates of the identified patient and the identified physician are tied together (block 507). The association file(s) and/or object(s) are then conveyed to the subscription log 200 (block 508), which uses the association file(s) and/or object(s) to create a corresponding subscription (block 510). Control then returns to block 500.

Referring back to block 500, if a physician initiated search is not detected, the new document detector 302 is triggered by a healthcare document (e.g., x-rays, scans, three-dimensional renderings, test results, observations, diagnosis, financial records, payments, etc.) being entered into the system 100 (e.g., in the XDS repository 110a via the medical information system 106) (block 512). As described herein, the medical documents include identifying data (e.g. metadata) associated with a patient, physician, treatment, healthcare enterprise, etc. Thus, in response to detecting the entrance of a healthcare document into the system 100, the new document detector 302 causes the data extractor 308 to use the identifying data to identify the physician(s) and patient(s) associated with the newly entered healthcare document (block 514). Using the extracted information, a corresponding subscription is then generated as described above in connection with blocks 506, 507, 508, and 510.

Referring back to block 512, if the entrance of a new document is not detected, the external database access unit 304 may then be triggered according to a schedule programmed therein. If scheduled to do so, (block 516), the external database access unit 304 accesses one or more external healthcare information resources to detect patients of interest for a group of physicians (block 518). The group of physicians includes, for example, practitioners enrolled in the medical data sharing system 100. To detect patients of interest to any of the group of physicians, the external database access unit 304 performs one or more searches and/or queries of external resources (e.g., XDS repositories of other medical data sharing systems, subscription logs stored in external systems, alternative medical record storage resources at one of more of the enterprises 102a-d of FIG. 1, etc.) using, for example, identifiers associated with the group of physicians. If the searched and/or queried resource(s) include any such information (block 520), the data extractor 308 extracts an identity of one or more patients related to the medical documents and determines for which of the physicians was the medical document identified (block 522). Using the extracted identifying information and an assumption of interest between the identified physician and the identified patient, a corresponding subscription is then generated as described above in connection with blocks 506, 507, 508, and 510.

In some examples, the external database access unit 304 performs a bulk import of information from the external resources described above and stores the same internally to be operated on at a future time. That is, operation of the external database access unit 304 can be independent of the availability of the external resource(s).

The illustrated example of FIG. 5 includes a plurality of example processes capable of generating the subscriptions described herein via the example subscription generator 208 (FIGS. 2 and 3). While the example processes (e.g., extracting data from a search, extracting data from a newly entered document, extracting data from an externally located document, etc.) are shown together in the example of FIG. 5, other examples may include one or more of the example processes operating individually at the same time according to separate schedules and/or prompts.

FIG. 6 is a block diagram of an example processor system 610 that may be used to implement the apparatus and methods described herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of generating a subscription for a healthcare event tracking and alerting system, comprising:
automatically analyzing healthcare information of a medical data sharing system to determine an interest of a physician in a patient;
obtaining a patient identifier corresponding to the patient from the healthcare information;
obtaining a physician identifier corresponding to the physician; and
associating the patient identifier with the physician identifier to generate a subscription to the healthcare event tracking and alerting system, wherein the subscription enables the physician to automatically receive notifications of data related to the patient.

2. A method as defined in claim 1, wherein the interest of the physician in the patient is to be assumed in response to a detection of a search initiated by the physician for information related to the patient.

3. A method as defined in claim 1, wherein analyzing the clinical information comprises detecting an initiation of a search of the medical data sharing system by the physician.

4. A method as defined in claim 3, wherein obtaining the patient identifier comprises extracting identifying information from data entered into a search field.

5. A method as defined in claim 3, wherein obtaining the physician identifier comprises detecting the physician identifier from system log on information.

6. A method as defined in claim 1, wherein analyzing the healthcare information comprises detecting an entrance of a healthcare document into the medical data sharing system.

7. A method as defined in claim 6, wherein the interest of the physician in the patient is to be assumed in response to a detection that the patient and the physician are listed in the healthcare document.

8. A method as defined in claim 6, wherein obtaining the physician identifier and obtaining the patient identifier comprise extracted identifying information from the healthcare document.

9. A method as defined in claim 1, wherein analyzing the healthcare information comprises accessing an external healthcare information resource and searching the external healthcare information resource using the physician identifier to identify a healthcare document listing the physician.

10. A method as defined in claim 9, wherein the interest of the physician in the patient is to be assumed in response to a detection that the patient and the physician are listed in the healthcare document.

11. A method as defined in claim 1, further comprising associating another patient identifier with the physician to generate another subscription in response to determining that the patient is associated with another patient by referencing an index including a plurality of relationships held between a plurality of persons.

12. An apparatus to generate a subscription for a healthcare event tracking and alerting system, comprising:
at least one detector to analyze healthcare information of a medical data sharing system to determine an interest of a physician in a patient;
a data extractor to obtain a patient identifier corresponding to the patient from the healthcare information, where the data extractor is to obtain a physician identifier corresponding to the physician; and
an association creator to associate the patient identifier with the physician identifier to generate a subscription to the healthcare event tracking and alerting system, wherein the subscription enables the physician to automatically receive notifications of data related to the patient.

13. An apparatus as defined in claim 12, wherein the interest of the physician in the patient is to be assumed in response to the detector detecting a search initiated by the physician for information related to the patient.

14. An apparatus as defined in claim 13, wherein the data extractor is to obtain the patient identifier by extracting identifying information from data entered into a search field.

15. An apparatus as defined in claim 13, wherein the data extractor is to obtain the physician identifier by detecting the physician identifier from system log on information.

16. An apparatus as defined in claim 12, wherein the detector is to analyze the healthcare information by detecting an entrance of a healthcare document into the medical data sharing system.

17. An apparatus as defined in claim 16, wherein the interest of the physician in the patient is to be assumed in response to the detector detecting that the patient and the physician are listed in the healthcare document.

18. An apparatus as defined in claim 12, further comprising an index including a plurality of relationships held between a plurality of persons, wherein the index is to be referenced to determine whether another patient identifier is to be associated with the physician to generate another subscription based on at least one of the relationships of the patient listed in the index.

19. An apparatus as defined in claim 12, wherein the detector is to analyze the healthcare information by accessing an external healthcare information resource and search the external healthcare information resource using the physician identifier to identify a healthcare document listing the physician.

20. A medical data sharing system configured to provide feedback to a healthcare practitioner, comprising:
a plurality of medical information systems to receive healthcare information implemented at a plurality of healthcare enterprises, wherein the enterprises are members of an agreement to share the healthcare information;
a tracking and alerting system to automatically provide feedback to a healthcare practitioner by storing a subscription to healthcare information associated with a patient of interest to the practitioner;
a subscription generator to generate the subscriptions by automatically detecting the interest in the patient by analyzing at least one of a search initiated by the physician and a healthcare document entered into the medical information systems in which the physician and the patient are listed.
